(19) United States
(12) Patent Application Publication
(10) Pub. No.: US 2005/0000346 A1
(43) Pub. Date: Jan. 6, 2005

(54) Slicer with antimicrobial impregnated surfaces

(76) Inventors: Howard A. Hartley, Brookville, OH (US); Terry K. Peterson, Charlotte, NC (US); John C. Baron, Troy, OH (US)

Correspondence Address: THOMPSON HINE LLP, 2000 COURTHOUSE PLAZA N.E., 10 WEST SECOND STREET, DAYTON, OH, 45402-1758, US

(21) Appl. No.: 10/922,251

(22) Filed: Aug. 19, 2004

Related U.S. Application Data
(63) Continuation of application No. 10/136,541, filed on May 1, 2002.
(60) Provisional application No. 60/288,951, filed on May 4, 2001.

(51) Int. Cl. B26D 7/06

(52) U.S. Cl. 83/714; 83/932

(57) ABSTRACT

A slicer has antimicrobial impregnated surfaces or components integrated into various parts of the slicer to reduce microbe growth.

The present invention is directed to a food product slicer with antimicrobial impregnated surfaces/components.

### BACKGROUND OF THE INVENTION

Food product slicers are widely used to slice various food products, such as meats, cheeses, vegetables, and the like. The slicers typically include a rotating blade, and a reciprocating carriage that brings the food product into contact with the blade to cut a slice off of the food product. When dealing with food processing equipment, it may be desired to reduce the presence of microbes.

### SUMMARY OF THE INVENTION

A slicer has antimicrobial impregnated surfaces or components integrated into various parts of the slicer to reduce microbe growth. Other objects and advantages of the present invention will be apparent from the following description and the accompanying drawings.

### BRIEF DESCRIPTION OF THE DRAWINGS

FIG. 1 is an end view of a slicer illustrating various components that may be impregnated with antimicrobial agents;

FIG. 2 is a cut-away front view of the slicer of FIG. 1; and

FIG. 3 is a rear view of the slicer of FIG. 1.

### DETAILED DESCRIPTION

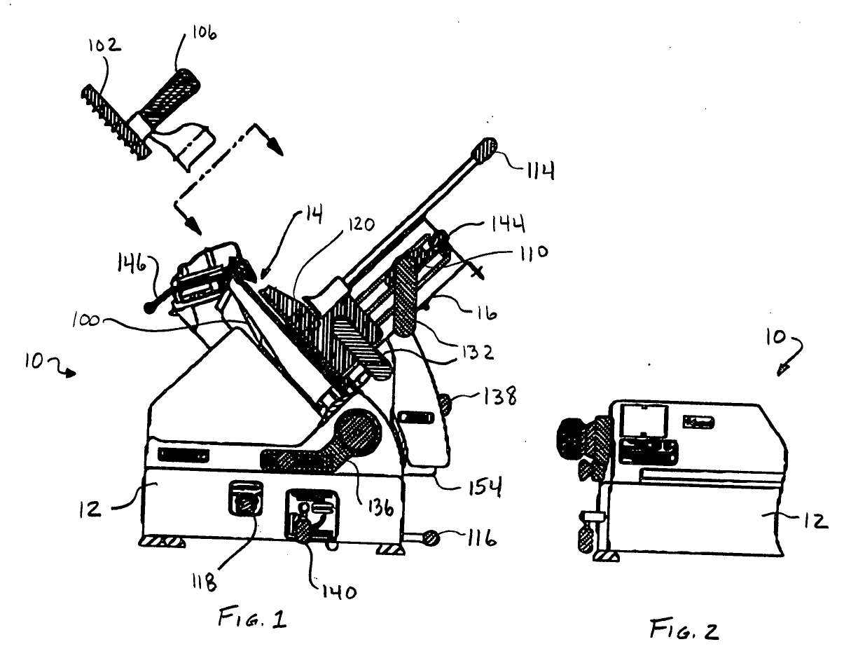

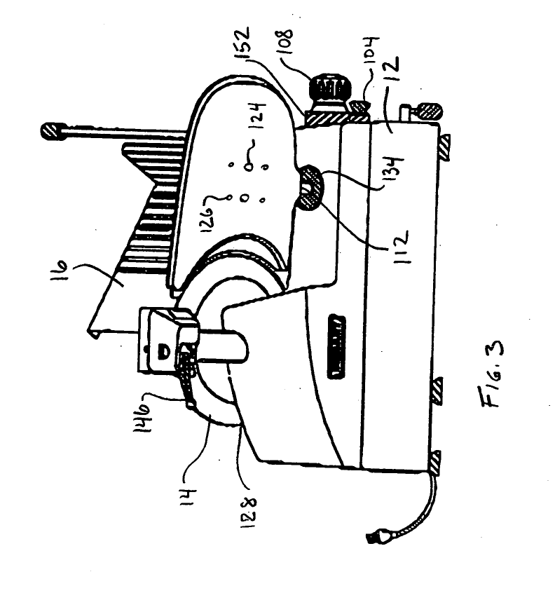

As shown in FIGS. 1-3, the slicer 10 includes a slicer body 12, a rotatable disk-like blade or knife 14, and a carriage 16 that reciprocates along the length of the body 12 to bring the food product (not shown) that is located on the carriage 16 into and out of contact with the blade 14. Various components of the slicer 10 may be made of antimicrobial impregnated surfaces. By way of example, various component of the carriage 16 and various control knobs may each be made of antimicrobial impregnated material. Components that are contacted by the food product to be sliced, or by the user, or by other machinery or surfaces may be desired to be made of antimicrobial impregnated material. Some of the components that may be made of antimicrobial impregnated material are identified in FIGS. 1-3. Some of the components that may be made of antimicrobial impregnated material may include the deflector mount 100, meat grip 102, on/off knob 104, meat grip handle 106, indexing knob 108, meat grip hanger cap 110, gauge plate bottom cover 112, slide rod assembly knob 114, lift lever handle 116, speed control knob 118, handle and slide rod support 120, cover retainer, pusher truing rod, hole plug 124, gauge plate hole plug 126, ring guard ferrule 128, knife shaft ring, carriage handles 132, drip ring 134, index bezel 136, support tray knob 138, lever knob 140, product deflector, meat grip hanger 144, sharpener handle 146, cover disk, sharpener truing arm, dial and scale assembly 152 and transport plug 154. Each of the components may be made of antimicrobial impregnated material, or may include a top layer of antimicrobial impregnated material located thereon. The antimicrobial agent may work continuously between cleanings to reduce the level or growth of odor and stain causing microorganisms over time.

The antimicrobial agent can be any of a wide variety of antimicrobial materials such as microbiocides, antimicrobial agents including phytochemicals and phytonutrients, or antibacterial or antifungal chemical additives. The antimicrobial agent can be incorporated into plastic and/or fiberglass resins on the surface of a component, or forming the bulk of the material of the component. For example, the antimicrobial agent may be a microbial agent sold under the trademark MICROBAN® sold by Microban (Americas) of Huntersville, N.C.

The antimicrobial agent may be incorporated into a fiberglass or plastic resin by a variety of methods, for example as disclosed in U.S. Pat. No. 5,919,554 to Watterson, III et al., hereby incorporated by reference. For example, the various components of the slicer may be made of antimicrobial fiber reinforced plastic (“FRP”) composites such as FRP composites having antimicrobial compounds or chemicals embedded in a polyester resin-containing composite. The FRP composite may have antimicrobial characteristics that inhibit bacterial, fungal, microbial and other pathogen growth, and the antimicrobial agents, compounds or chemicals may be embedded in the FRP composite during manufacture of the composite. Using a solubilizing agent carrier system, an antimicrobial additive may be incorporated into the amorphous zones of the molecular structure of a polyester resin from which FRP composites are formed, thereby incorporating the antimicrobial agent into the FRP composite. The levels of antimicrobial additive in the FRP composite, incorporated in the manner above, results in substantive controlled migration from the amorphous zones of the molecular structure of the polyester resin to the surface of the FRP composite, until a point of equilibrium is reached. As the surface of the FRP composite is abraded during use as equilibrium is disrupted, additional migration is stimulated, until equilibrium is again reached.

The FRP composite can be made from a polyester resin composition and a broad spectrum antimicrobial agent that are batch processed and formed into the slicer components. The polyester resin composition may include a polyester resin, fiber reinforcements and a curing catalyst. A polymer resin gel coat, preferably a polyester resin gel coat, may be optionally formed with the polyester resin composition to enhance the surface properties of the FRP composite. The broad spectrum antimicrobial agents associated therewith can inhibit bacterial, fungal, viral and other pathogen growth. Preferably, an antimicrobial agent is associated or incorporated into the polyester resin from which the FRP composite is made. Thus, an effective amount of an antimicrobial substance (e.g., 5-chloro-2-(2,4-dichlorophenoxy) phenol) is incorporated therein. Levels of active ingredients or antimicrobial substances may range from about 0.1% to about 5% by weight of the FRP composite. The antimicrobial agent incorporated into the FRP composite may exhibit controlled migration through the polyester resin composition and polyester resin gel coat despite the highly crystalline structure of the polyester resin.

Having described the invention in detail and by reference to the preferred embodiments, it will be apparent that modifications and variations thereof are possible without departing from the scope of the invention.

1. A food product slicer comprising:
a body;
a rotatable knife positioned on the body;
a carriage mounted for reciprocation on the body past an edge of the rotatable knife;
a plurality of components comprised of a fiberglass or plastic resin having an antimicrobial agent incorporated therein, the plurality of components including at least a meat grip, a meat grip handle, a carriage handle, an on/off knob and an indexing knob, the antimicrobial agent acting to reduce microorganism growth on the components over time.

2. A food product slicer comprising:
a body;
a rotatable knife positioned on the body;
a carriage mounted for reciprocation on the body past an edge of the rotatable knife;
a plurality of components comprised of a fiberglass or plastic resin having an antimicrobial agent incorporated therein, the plurality of components including at least one food product contacting component of the slicer and at least one user contacted component of the slicer, the antimicrobial agent acting to reduce microorganism growth on the components over time.

3. The food product slicer of claim 2 wherein a both a meat grip and meat grip handle are comprised of the fiberglass or plastic resin having an antimicrobial agent incorporated therein.

4. The food product slicer of claim 3 wherein each of a on/off knob, indexing knob, and speed control knob are comprised of the fiberglass or plastic resin having an antimicrobial agent incorporated therein.

5. The food product slicer of claim 4 wherein each of a carriage handle and a handle and slide rod support are comprised of the fiberglass or plastic resin having an antimicrobial agent incorporated therein.

6. The food product slicer of claim 5 wherein each of a gauge plate bottom cover and a sharpener handle are comprised of the fiberglass or plastic resin having an antimicrobial agent incorporated therein.

7. A food product slicer comprising:
a body;
a rotatable knife positioned on the body;
a carriage mounted for reciprocation on the body past an edge of the rotatable knife;
at least one component comprised of a fiberglass or plastic resin having an antimicrobial agent incorporated therein, the antimicrobial agent acting to reduce microorganism growth on the component over time.

8. The food product slicer of claim 1 wherein the meat grip contacts food during slicing operations of the slicer.

9. The food product slicer of claim 2 wherein the food product contacting component contacts food during slicing operations of the slicer.

10. The food product slicer of claim 7 wherein the component contacts food during slicing operations of the slicer.
